(19) United States
(12) Patent Application Publication
(10) Pub. No.: US 2023/0065371 A1
(43) Pub. Date: Mar. 2, 2023

(54) PROCESS FOR MANUFACTURING SOLID NEUTRAL AMINO ACID SALTS OF POLYUNSATURATED FATTY ACIDS

(71) Applicant: SILICYCLE INC., Québec (CA)

(72) Inventors: Xiaowei WU, Québec (CA); Christophe MELLON, Québec (CA); Claudia CARPENTIER, Québec (CA); Xavier PIGEON, Québec (CA)

(21) Appl. No.: 17/758,745

(22) PCT Filed: Jan. 29, 2021
(86) PCT No.: PCT/CA2021/050096

§ 371 Date: Jul. 13, 2022

Related U.S. Application Data
(60) Provisional application No. 62/967,667, filed on Jan. 30, 2020.

(51) Int. Cl. C11C 3/00; C11C 1/00; A23L 33/175

(52) U.S. Cl. CPC C11C 3/00; C11C 1/002; A23L 33/175; A23V 2002/00

(57) ABSTRACT

The present disclosure relates to the neutral amino acid salts of polyunsaturated fatty acid (PUFAs), and a process for producing same comprising mixing one or more PUFA in an acid form, an alkali base and a neutral amino acid in a mixture of a first organic solvent and water, adding a second organic solvent to the mixture in an amount effective for precipitating the salts of PUFAs, and evaporating the first and second organic solvents and water to recover the neutral amino acid salts of PUFAs.

### FIELD OF THE DISCLOSURE

The present disclosure relates to the neutral amino acid salts of polyunsaturated fatty acids (PUFAs), and a process for producing same.

### BACKGROUND

In the ′80s, several publications have revealed that the traditional Greenlandic diet rich in marine mammals and fish has substantially lowered mortality from ischaemic heart disease (IHD) in the Inuit population and Danish settlers, albeit to different levels. Such fact is believed to contribute to the effects of polyunsaturated fatty acids (PUFAs) in the traditional marine diet.

Interest in omega-3 (ω-3) has escalated in recent years because of the proposed positive effects on human beings, such as anti-inflammatory and anti-blood clotting actions, lowering triglyceride (TAG) levels, reducing blood pressure, and reducing the risks of diabetes, some cancers, etc.

However, the use of PUFAs as a food additive or food supplement is limited by stability problems as well as unpleasant taste and odor.

### SUMMARY OF THE DISCLOSURE

An aspect of the disclosure relates to a process for preparing at least one neutral amino acid salt of polyunsaturated fatty acids (PUFAs) comprising: mixing one or more PUFA in an acid form, an alkali base and a neutral amino acid in a mixture of a first organic solvent and water at a temperature of between about above 0° C. to about the boiling point of said first organic solvent; adding a second organic solvent to said mixture of said first organic solvent and water, in an amount effective for precipitating said salts of PUFAs; and evaporating said first and second organic solvents and water to recover said neutral amino acid salts of PUFAs.

In an embodiment, the neutral amino acid salt of PUFAs is in a solid form.

In an embodiment, the PUFAs are comprising at least one of omega-3 and omega-6 PUFAs.

In another embodiment, the omega-3 PUFAs are comprising at least one of docosahexaenoic acid (C22:6 (n−3)) (DHA), eicosapentaenoic acid (20:5n−3) (EPA) and alpha-linolenic acid (C18:3 (n−3)) (ALA).

In an alternative embodiment, the omega-3 PUFAs comprise at least one of eicosatrienoic acid (C20:3 (n−3)) (ETE), eicosatetraenoic acid (C20:4 (n−3)) (ETA), heneicosapentaenoic acid (C21:5 (n−3)) (HPA), docosapentaenoic acid (C22:5 (n−3)) (DPA), tetracosapentaenoic acid (C24:5 (n−3)), and tetracosahexaenoic acid (C24:6 (n−3)).

In an embodiment, the omega-6 PUFAs comprise at least one of linoleic acid (C18:2 (n−6)) and arachidonic acid (C20:4 (n−6)).

In another embodiment, the omega-6 PUFAs comprise at least one of eicosadienoic acid (C20:2 (n−6)), dihomo-gamma-linolenic acid (C20:3 (n−6)) (DGLA), docosadienoic acid (C22:2 (n−6)), adrenic acid (C22:4 (n−6)), docosapentaenoic acid (C22:5 (n−6)); tetracosatetraenoic acid (C24:4 (n−6)); and tetracosapentaenoic acid (C24:5 (n−6)).

In a supplemental embodiment, the PUFAs are comprised in a fat and/or oil.

In a further embodiment, the PUFAs comprise EPA.

In another embodiment, the PUFAs comprise DHA.

In an embodiment, the PUFAs are comprised in a tuna oil.

In another embodiment, the PUFAs comprise 50-55% DHA and 20-25% of EPA.

In a further embodiment, the PUFAs comprise 45-60% DHA and 18-27% of EPA.

In an additional embodiment, the PUFAs are comprised in seal oil.

In an embodiment, the PUFAs comprise 5-40% DHA, 5-45% of EPA and 3-10% DPA.

In an embodiment, the mixing step comprises providing an organic solution comprising said one or more PUFA in an acid form in said first organic solvent, providing an aqueous solution comprising said neutral amino acid and water, and mixing said organic solution and said aqueous solution.

In another embodiment, the neutral amino acids comprise glycine, α-alanine, β-alanine, taurine, leucine, isoleucine, methionine, serine, cysteine, threonine, tyrosine, proline, phenylalanine, homoserine, γ-aminobutyric acid (GABA), statine, or combinations thereof.

In a supplemental embodiment, the neutral amino acid is glycine.

In an embodiment, the neutral amino acid is α-alanine.

In a further embodiment, the neutral amino acid is β-alanine.

In another embodiment, the neutral amino acid is taurine.

In an embodiment, the second organic solvent is ethanol or acetonitrile.

It is also encompassed a neutral amino acid salt of polyunsaturated fatty acid (PUFAs) prepared by the process as defined herein.

### DETAILED DESCRIPTION

The disclosure relates to a strategy of preparing neutral amino acid salts of PUFAs, which leads to the formation of free-flowing powder in one step.

The term “polyunsaturated fatty acid” or “PUFA” as used herein means fatty acid compounds containing two or more ethylenic carbon-carbon double bonds in their carbon backbone. Two major classes of PUFAs are omega-3 and omega-6 PUFAs, characterized by the position of the final double bond in the chemical structure of PUFAs.

Omega-3 PUFAs refer to the position of the final double bond, which in omega-3, the double bond is between the third and fourth carbon atoms from the “omega” or tail end of the molecular chain.

The three most important omega-3 PUFAs are docosahexaenoic acid (DHA), which has 22 carbons and 6 double bonds beginning with the third carbon from the methyl end and is designated as (C22:6 (n−3)), eicosapentaenoic acid (EPA), which is designated as (20:5 (n−3)), and alpha-linolenic acid (ALA) which is designated as (C18:3 (n−3)).

Other omega-3 PUFAs include: Eicosatrienoic acid (ETE) (C20:3 (n−3)), Eicosatetraenoic acid (ETA) (C20:4 (n−3)), Heneicosapentaenoic acid (HPA) (C21:5(n−3)), Docosapentaenoic acid (Clupanodonic acid) (DPA) (C22:5 (n−3)), Tetracosapentaenoic acid (C24:5 (n−3)), and Tetracosahexaenoic acid (Nisinic acid) (C24:6 (n−3)).

Omega-6 PUFAs have their terminal double bond in what is referred to as the omega six-position, meaning the last double bond occurs at the sixth carbon from the omega end of the fatty acid molecule.

Among the omega-6 PUFAs, linoleic acid (C18:2 (n−6)) and arachidonic acid (C20:4 (n−6)) are two of the major omega-6s.

Other omega-6 PUFAs include: Eicosadienoic acid (C20:2(n−6)), Dihomo-gamma-linolenic acid (DGLA) (C20:3 (n−6)), Docosadienoic acid (C22:2 (n−6)), Adrenic acid (C22:4 (n−6)), Docosapentaenoic acid (Osbond acid) (C22:5 (n−6)), Tetracosatetraenoic acid (C24:4 (n−6)), and Tetracosapentaenoic acid (C24:5 (n−6)).

The terms “fat” and/or “oil” used herein refer to any fat and/or oil containing a level of PUFAs suitable for use in the process described herein. The PUFA esters present in the fat or oil are as alkyl esters, triglycerides, diglycerides or monoglycerides, or a mixture thereof. In the case of diglycerides or triglycerides, the glycerol unit may optionally bear a phosphorus derivative (hence the fat and/or oil could be or contain phospholipids).

The term “alkali base” as used herein refers to any alkali metal base, such as alkali hydroxide bases. Examples of alkali hydroxide bases are NaOH, LiOH, KOH or combinations thereof.

The “first organic solvent” as used herein refers to any organic solvent (in class 3) which is miscible with water. The first organic solvent also allows for dissolving said one or more PUFA (or fat/oil containing same) at least at a ratio of >0-20 (wt/wt).

The term “neutral amino acid” as used herein refers to any amphiprotic compound, preferably non-toxic and edible and more preferably from a natural source, comprising one primary amine group and either one carboxylic (—COOH) group, sulfonic (—SO₃H) group or phosphonic (—P(O) (OH)₂) group, therefore excluding esters of those acid groups. The amino acid is preferably a non-aromatic amino acid.

The term “neutral amino acids” as used herein refers to neutral amino acids and derivatives thereof that are part of the category of Generally Recognized as Safe (GRAS) compounds and having a single primary amine group and a molecular weight of less than about 200 g/mol.

Neutral amino acids exclude arginine, lysine, aspartic acid, and glutamic acid.

Neutral amino acids may include the group consisting of glycine, α-alanine, β-alanine, taurine, leucine, isoleucine, methionine, serine, cysteine, threonine, tyrosine, proline, phenylalanine, homoserine, γ-aminobutyric acid (GABA), statine, and combinations thereof.

The “second organic solvent” used herein means the solvents which can cause the precipitation of the amino acid salt of PUFA.

As discussed above, an aspect relates to a process for producing at least one neutral amino acid salt of one or more polyunsaturated fatty acids (PUFAs), the process comprising: mixing one or more PUFA in an acid form, an alkali base and a neutral amino acid in a mixture of a first organic solvent and water at a temperature of between about above 0° C. to about the boiling point of said first organic solvent; adding a second organic solvent to said mixture of said first organic solvent and water, in an amount effective for precipitating said salts of PUFAs; and evaporating said first and second organic solvents and water to recover said neutral amino acid salts of PUFAs.

As used herein, “atmospheric condition” refers to the step or process being conducted at room temperature (e.g. about 20-25° C.) and atmospheric pressure. The process herein is preferably conducted at atmospheric pressure and at room temperature.

The process herein may be conducted without using inert gas.

In one embodiment, the mixing step includes providing an organic solution comprising said one or more PUFA in an acid form in said first organic solvent, providing an aqueous solution comprising said neutral amino acid and mixing said organic solution and said aqueous solution.

In one embodiment, said neutral amino acid salts of PUFAs are in a solid form, as for example in a powder. In a further embodiment, the powder is a free-flowing powder.

In one embodiment, the process further comprises a step of subjecting the neutral amino acid salts of PUFAs to roughing pump.

In one embodiment, the one or more PUFAs are EPAs comprising over 90% wt/wt of omega-3 PUFAs EPA over the total amount of PUFAs.

In one embodiment, the one or more PUFAs are DHAs comprising over 90% wt/wt of omega-3 PUFAs DHA over the total amount of PUFAs.

In one embodiment, the omega-3 PUFAs are from tuna oil consisting of 50-55% wt/wt of DHA and 20-25% wt/wt of EPA, alternatively 45-60% wt/wt of DHA and 18-27% wt/wt of EPA over the total amount of PUFAs.

In one embodiment, the omega-3 PUFAs are from seal oil consisting of 5-40% wt/wt of DHA, 5-45% wt/wt of EPA and 3-10% wt/wt of DPA over the total amount of PUFAs.

In one embodiment, the first organic solvent is ethanol.

In one embodiment, the first organic solvent is methanol.

In one embodiment, the first organic solvent is a mixture of ethanol and methanol.

In one embodiment, the first organic solvent is isopropanol.

In one embodiment, the first organic solvent is butanone.

In one embodiment, the first organic solvent is acetone.

In one embodiment, the first organic solvent is THF.

In one embodiment, the neutral amino acid is glycine.

In one embodiment, the neutral amino acid is α-alanine.

In one embodiment, the neutral amino acid is β-alanine.

In one embodiment, the neutral amino acid is taurine.

The exact stoichiometry of the neutral amino acid equivalent to the alkali base is used to form the aqueous solution. The weight ratio of the aqueous solution to neutral amino acid is dependent on the nature of the amino acid. The aqueous component can be used as the least amount to dissolve the amino acid up to 10 times of the least amount, wherein said dissolution is achieved when no substantial amount of solid basic amino acid is visually present in the aqueous component, the dissolution being conducted at room temperature (i.e. from about 20-25 degrees Celsius). In one embodiment, the amount used is 2 times of the least amount, or 4 times of the least amount, or 5 times of the least amount.

In one embodiment, the molar ratio of the neutral amino acid to the alkali base and to the oil is 0.9-1.1:0.9-1.1:0.9-1.1 or 0.95-1.0.5:0.95-1.05:0.95-1.05. In a further embodiment, the molar ratio is 1:1:1.

In one embodiment, the weight ratio of the second organic solvent to the oil mixture is 10:1 to 100:1, 10:1 to 70:1, 10:1 to 50:1, preferably 10:1 to 30:1. The second organic solvent is preferably one that: 1) can be removed under the evaporation step together with the first organic solvent and water; 2) has a similar boiling point as that of water (e.g. a boiling point of about 75 degrees Celsius and higher) in order to remove both of organic solvent and water at the same time (to avoid the organic solvent to be first removed and cause the final product to be as sticky solid; 3) trace amount of the solvent be safe to the consumer (i.e. low toxicity).

In one embodiment, the second organic solvent is acetonitrile.

In one embodiment, the second organic solvent is ethanol.

The exact stoichiometry of the neutral amino acid equivalent to said one or more PUFA in free acid is difficult to establish with certainty when using fat or oil because of, for example, the indefinite molecular weight of fish oil. In addition, the sources of fish oil differ from one another and may contain different species proportions, such as the variety of proportion of ω-3 composition, ω-6 composition and saturated fatty acids. However, the skilled person can easily estimate the molecular weight by making the assumption that the carbon length of the fatty acid composition is in the range of C14-C24. An assumption is made that the fatty acids have an average length of carbon chain of C19. Thus, the molecular weight of 300 g/mol is used herein to estimate the amount of neutral amino acids used for the formation of fatty acid salts.

The amount of neutral amino acid required to fabricate the fatty acid salt is 1-1.5 mole of neutral amino acid for every mole of fatty acid, preferably 1 mole would be sufficient.

The rotor-stator homogenizer may be used for the mixing process. Typically, the homogenizer speed is from 50 rpm to 1000 rpm, preferably, from 100-200 rpm.

The final product in powder form is isolated by evaporating said first and second organic solvents and water from the reaction mixture to recover said basic amino acid salts of PUFAs. Preferably, said evaporation step is carried under reduced pressure between about 0° C.-70° C. depending on the properties of the equipment used. The oxidative status of the obtained final product described herein is quantified by peroxide value (PV), anisidine value (AV) and Totox value. PV is a measure of the level of the primary oxidation products (lipid hydroperoxides) in the product, which is specified in milliequivalents O₂ per kg of sample, while the AV is an unspecific measure of saturated and unsaturated carbonyl compounds. Totox is calculated by the equation Totox=2*PV+AV.

The comparison of oxidative status of amino acid salts of omega-3, starting material in ester form and fish oil in free acid form are assessed by measuring the PV and AV, then all the samples are subjected to the same oxidizing condition over a certain period of time, followed by the measuring PV and AV of the samples. The oxidizing conditions are selected from one of them as below: 1) Storage in closed containers at atmospheric condition for 7 months; or 2) Storage in loose closed containers exposed to air at 40° C. for 1 month.

In one embodiment, the neutral amino acid salts of PUFAs are synthesized following the general procedure with eicosapentaenoic acid (EPA) with the concentration of >90% wt/wt over the total amount of PUFAs, and PV >50 meqO₂/kg and AV of >100 A/g. The molar percent range of EPA to neutral amino acid is 30%-50%/70%-50%, 40-50%/60-50%, 45-50%/55-50% respectively and preferentially the molar percent composition is of 50%/50%. The solvents are removed at reduced pressure 0-70 mmHg at 0° C.-70° C., preferentially at 30 mmHg at 40° C., followed by the roughing pump for a day.

In one embodiment, the neutral amino acid salts of PUFAs are synthesized following the general procedure with docosahexaenoic acid (DHA) with the concentration of >90% wt/wt over the total amount of PUFAs, and a PV of >50 meqO₂/kg and AV of >100 A/g. The molar percent range of DHA to neutral amino acid is 30%-50%/70%-50%, 40-50%/60-50%, 45-50%/55-50% respectively and preferentially the molar percent composition is of 50%/50%. The solvents are removed at reduced pressure 0-70 mmHg at 0° C.-70° C., preferentially at 30 mmHg at 40° C., followed by the roughing pump for a day.

In one embodiment, the neutral amino acid salts of PUFAs are synthesized following the general procedure with seal oil as free acid with EPA of 5-45% wt/wt, DHA of 5-40% wt/wt and DPA of 3-10% wt/wt over the total amount of PUFAs. The molar percent range of seal oil as free acid to neutral amino acid is 30%-50%/70%-50%, 40-50%/60-50%, 45-50%/55-50% respectively and preferentially the molar percent composition is of 50%/50%. The solvents are removed at reduced pressure 0-70 mmHg at 0° C.-70° C., preferentially at 30 mmHg at 40° C., followed by the roughing pump for a day.

In one embodiment, the neutral amino acid salts of PUFAs are synthesized following the general procedure with tuna oil as free acid containing EPA of 20-25% wt/wt and DHA of 50-56% wt/wt over the total amount of PUFAs. The molar percent range of tuna oil to neutral amino acid is 30%-50%/70%-50%, 40-50%/60-50%, 45-50%/55-50% respectively and preferentially the molar percent composition is of 50%/50%. The solvents are removed by filtration, followed by the roughing pump for a day.

Sample Characterization

Food Lab Analyzer: Among several techniques known in the art for determining the oxidative levels of a sample. The CDR FoodLab® Junior analyzer is used herein for determining PV and AV. The procedures are as described below:

The solid product 0.5 g was dissolved in 2 ml of MeOH and HCl solution with the ratio of 1:10 (v/v). The mixture was stirred for 5 minutes, followed by the addition of 5 ml of water. The mixture was extracted with 3 ml of hexane containing 100 ppm butylhydroxytoluene (BHT). The organic layer was dried over MgSO₄, filtrated and evaporated under reduced pressure at the temperature of 0-70° C. to get the fish oil in free acid form, which is evaluated with the CDR FoodLab® Junior analyzer to get anisidine and peroxide values using the CDR FoodLab® Junior analyzer.

Gas chromatography-mass spectrometry (GC-MS): The PUFAs concentrates of the final product are determined by gas chromatography-mass spectrometry (GC-MS).

Esterification of PUFAs: Around 25 mg of free fatty acid (FFA) or FFA salts was provided in a sealed tube, and 2 ml of a solution of 2% H₂SO₄ was added to generate a homogenous solution, which was then heated (without any agitation) at 80° C. for 30 minutes, followed by the addition of 2 ml of saturated NaHCO₃ aqueous solution after the solution was cooled down to room temperature. The FFA in ester form was extracted with 8-10 ml of 100 ppm BHT hexanes once. Subsequently, the organic layer was dried over MgSO₄ and analysed by GC-MS.

Water Quantification in spheroidal organosiloxane sub-micron/nanoparticles (Karl Fisher): The water percentage was estimated by using titrator Compact V20s from Mettler Toledo.

### EXAMPLES

Example 1: The preparation of tuna oil in free acid form PUFAs ethyl ester of tuna oil.

A 2 L of 3-neck round bottle glassware was provided with 200 mL of ethanol, and followed by the addition of 64 g of 50% of NaOH aqueous solution. Subsequently, PUFAs ethyl ester of tuna oil with an AV of 6.8 A/g and a PV of 13 meqO₂/kg was added to the mixture under nitrogen and stirred at the speed of 150 rpm with the overhead stirrer. The resulting solution was stirred for 1.5 hour at room temperature. After cooling down to room temperature, 600 mL of H₂O and 60 mL of H₃PO₄ (85%) were added, which was stirred for 10 minutes. The organic phase was then extracted with 60 mL of hexane once and was dried over MgSO₄. After removing the organic solvent, 170 g of tuna oil in free acid form with EPA of 23.7% and DHA of 55.6% was generated as oil with a PV of 1.99 meqO₂/kg and an AV of <0.5 A/g.

Example 2: The preparation of glycine salt of eicosapentaenoic acid (EPA-gly).

A 500 mL round bottle flask was first provided with 6 g of EPA, exhibiting a PV of >50 meqO₂/kg and an AV of >100 A/g, and 20 g of ethanol, followed by the addition of 2 g of 40% of NaOH aqueous solution containing 1.5 g of glycine. The molar ratio of EPA, NaOH and glycine was 1:1:1. The mixture was stirred at atmospheric condition (i.e. atmospheric pressure and room temperature) for 5 minutes to obtain a suspension solution. 100 mL of acetonitrile was added to further precipitate the glycine salt. Subsequently, the solvents were evaporated under reduced pressure of 30 mmHg at 40° C. to achieve the final product as a brown powder, which was further subject to roughing pumper for 1 day to generate EPA-gly with a PV of 29.9 meqO₂/kg and an AV of 14.6 A/g. About 8 g of EPA-gly was stored in a 20 ml of clear vial with a diameter of 27 mm, which was placed with closed lids on the bench at room temperature for the stability examination for 60 days. The results are summarized in table 1.

Example 3: The preparation of glycine salt of docosahexaenoic acid (DHA-gly).

A 500 mL round bottle flask was first provided with 6 g of DPA, exhibiting a PV of >50 meqO₂/kg and an AV of >100 A/g, and 20 g of ethanol, followed by the addition of 2 g of 40% of NaOH aqueous solution containing 1.5 g of glycine. The molar ratio of EPA, NaOH and glycine was 1:1:1. The mixture was stirred at atmospheric condition for 5 minutes to obtain a suspension solution. 100 mL of acetonitrile was added to further precipitate the glycine salt. Subsequently, the solvents were evaporated under reduced pressure of 30 mm Hg at 40° C. to achieve the final product as a brown powder, which was further subject to roughing pumper for 1 day to generate DHA-gly with a PV of 9.71 meqO₂/kg and an AV of >100 A/g. About 8 g of DHA-gly was stored in a 20 ml of clear vial with a diameter of 27 mm, which was placed with closed lids on the bench at room temperature for the stability examination for 60 days. The results are summarized in table 1.

Example 4: The preparation of glycine salt of tuna oil in free acid form (EPA of 23.7% and DHA of 55.6%) (tuna-gly).

A 500 mL round bottle flask was first charged with 6 g of tuna oil in free acid form, exhibiting a PV of 1.99 meqO₂/kg and an AV of <0.5 A/g, and 20 g of ethanol, followed by the addition of 2 g of 40% of NaOH aqueous solution containing 1.5 g of glycine. The molar ratio of fish oil, NaOH and glycine was 1:1:1. The mixture was stirred at atmospheric condition for 5 minutes to obtain a suspension solution. 100 mL of acetonitrile was added to further precipitate the glycine salt. Subsequently, the solvents were evaporated under reduced pressure of 30 mm Hg at 40° C. to achieve the final product as a light yellow powder, which was further subject to roughing pumper for 1 day to generate tuna-gly with a PV of 1.01 meqO₂/kg and an AV of 1.3 A/g. About 8 g of tuna-gly was stored in a 20 ml of clear vial with a diameter of 27 mm, which was placed with closed lids on the bench at room temperature for the stability examination for 30 days and was further assessed by storing the vial with opened lids in an oven with an opened ventilation at 45° C. for another 30 days. The obtained results are summarized in tables 1 and 2.

Example 5: The preparation of glycine salt of seal oil in free acid form (EPA of 20.2%, DHA of 25.3% and DPA of 7.7%) (seal-gly).

A 250 mL round bottle flask was first provided with 3 g of seal oil in free acid form, exhibiting a PV of >50 meqO₂/kg and an AV of 47.7 A/g, and 10 g of ethanol, followed by the addition of 1 g of 40% of NaOH aqueous solution containing 0.75 g of glycine. The molar ratio of fish oil, NaOH and glycine was 1:1:1. The mixture was stirred at atmospheric condition for 5 minutes to obtain a suspension solution. 100 mL of acetonitrile was added to further precipitate the glycine salt. Subsequently, the solvents were evaporated under reduced pressure of 30 mmHg at 40° C. to achieve the final product as a yellow powder, which was further subject to roughing pumper for 1 day to generate Seal-gly with a PV of 6.32 meqO₂/kg and an AV of 11.3 A/g. About 4 g of seal-gly was stored in a 20 ml of clear vial with a diameter of 27 mm, which was placed with closed lids on the bench at room temperature for the stability examination for 60 days. The results are summarized in table 1.

Example 6: The preparation of α-alanine salt of tuna oil in free acid form (EPA of 23.7% and DHA of 55.6%) (tuna-α-ala).

A 500 mL round bottle flask was first provided with 6 g of tuna oil in free acid form, exhibiting a PV of 1.99 meqO₂/kg and an AV of <0.5 A/g, and 20 g of ethanol, followed by the addition of 2 g of 40% of NaOH aqueous solution containing 1.8 g of α-alanine. The molar ratio of fish oil, NaOH and α-alanine was 1:1:1. The mixture was stirred at atmospheric condition for 5 minutes to obtain a suspension solution. 100 mL of acetonitrile was added to further precipitate the α-alanine salt. Subsequently, the solvents were evaporated under reduced pressure of 30 mmHg at 40° C. to achieve the final product as a yellow powder, which was further subject to roughing pumper for 1 day to generate tuna-α-ala with a PV of 2.07 meqO₂/kg and an AV of 0.9 A/g. About 8 g of tuna-α-ala was stored in a 20 ml of clear vial with a diameter of 27 mm, which was placed with closed lids on the bench at room temperature for the stability examination for 30 days and was further assessed by storing the vial with opened lids in an oven with an opened ventilation at 45° C. for another 30 days. The obtained results are summarized in table 2.

Example 7: The preparation of β-alanine salt of tuna oil in free acid form (EPA of 23.7% and DHA of 55.6%) (tuna-β-ala).

A 500 mL round bottle flask was first provided with 6 g of tuna oil in free acid form, exhibiting a PV of 1.99 meqO₂/kg and an AV of <0.5 A/g, and 20 g of ethanol, followed by the addition of 2 g of 40% of NaOH aqueous solution containing 1.8 g of β-alanine. The molar ratio of fish oil, NaOH and β-alanine was 1:1:1. The mixture was stirred at atmospheric condition for 5 minutes to obtain a suspension solution. 100 mL of acetonitrile was added to further precipitate the β-alanine salt. Subsequently, the solvents were evaporated under reduced pressure of 30 mmHg at 40° C. to achieve the final product as a yellow powder, which was further subject to roughing pumper for 1 day to generate PUFAs-gly with a PV of 0.97 meqO₂/kg and an AV of 0.8 A/g. About 8 g of tuna-β-ala was stored in a 20 ml of clear vial with a diameter of 27 mm, which was placed with closed lids on the bench at room temperature for the stability examination for 30 days and was further assessed by storing the vial with opened lids in an oven with an opened ventilation at 45° C. for another 30 days. The obtained results are summarized in table 2.

Example 8: The preparation of taurine salt of tuna oil in free acid form (EPA of 23.7% and DHA of 55.6%) (tuna-tau).

A 500 mL round bottle flask was first provided with 6 g of tuna oil in free acid form, exhibiting a PV of 1.99 meqO₂/kg and an AV of <0.5 A/g, and 20 g of ethanol, followed by the addition of 2 g of 40% of NaOH aqueous solution containing 2.5 g of taurine. The molar ratio of fish oil, NaOH and taurine was 1:1:1. The mixture was stirred at atmospheric condition for 5 minutes to obtain a suspension solution. 100 mL of acetonitrile was added to further precipitate the taurine salt. Subsequently, the solvents were evaporated under reduced pressure of 30 mmHg at 40° C. to achieve the final product as a yellow powder, which was further subject to roughing pumper for 1 day to generate tuna-tau with a PV of 1.69 meqO₂/kg and an AV of <0.5 A/g. About 8 g of tuna-tau was stored in a 20 ml of clear vial with a diameter of 27 mm, which was placed with closed lids on the bench at room temperature for the stability examination for 30 days and was further assessed by storing the vial with opened lids in an oven with an opened ventilation at 45° C. for another 30 days. The obtained results are summarized in table 2.

TABLE 1
Assessment of stability of Glycine salt of DHA (DHA-
gly), EPA (EPA-gly) and seal oil (seal oil-gly)

| | | PV/meq | AV/ | |
|---|---|---|---|---|
| Sample | Time/d | O2/Kg | A/g | TOTOX |
| DHA-OH | Starting | >50 | >100 | — |
| | material | | | |
| EPA-OH | Starting | >50 | >100 | — |
| | material | | | |
| DHA-gly | 1 | 9.71 | >100 | — |
| | 60 | 1.92 | 7.4 | 11.24 |
| EPA-gly | 1 | 29.9 | 14.6 | 74.4 |
| | 60 | 1.19 | <0.5 | 2.38 |
| Seal oil- | 1 | 6.32 | 11.3 | 23.94 |
| gly | 60 | 0.73 | <0.5 | 1.46 |

TABLE 2
Assessment of stability of Tuna oil in the form of ester (tuna-OEt),
free acid (tuna-OA), sodium tuna oil salt and tuna oil as amino
acids salts, which are glycine, α-alanine, β-alanine and taurine

| | | PV/meq | AV/ | |
|---|---|---|---|---|
| Sample | Time/d | O2/Kg | A/g | TOTOX |
| Tuna-OA | 1 | 1.2 | <0.5 | 2.4 |
| | 31 | >50 | 28.1 | — |
| Tuna-OEt | 1 | 31.9 | 18.7 | 82.5 |
| | 31 | >50 | 24.2 | — |
| Tuna-Na | 1 | 3.21 | 3.9 | 10.32 |
| | 31 | 19.8 | >100 | — |
| Tuna-gly | 1 | 1.01 | 1.3 | 3.23 |
| | 31 | 0.92 | 0.6 | 2.42 |
| | 30* | 0.88 | <0.5 | 1.76 |
| Tuna-α-ala | 1 | 2.07 | 0.9 | 5.04 |
| | 31 | 3.12 | 1.4 | 7.64 |
| | 30* | 1.51 | <0.5 | 3.02 |
| Tuna-β-ala | 1 | 0.97 | 0.8 | 2.74 |
| | 31 | 1.11 | <0.5 | 2.22 |
| | 30* | 1.06 | <0.5 | 2.12 |
| Tuna-tau | 1 | 1.69 | <0.5 | 3.38 |
| | 31 | 2.42 | <0.5 | 4.84 |
| | 30* | 1.51 | 1.2 | 4.22 |

Note:
*The sample is placed at 45° C. with opened lid during the period of 30 days.

While the present disclosure has been described in connection with specific embodiments thereof, it will be understood that it is capable of further modifications and this application is intended to cover any variations, uses, or adaptations including such departures from the present disclosure as come within known or customary practice within the art and as may be applied to the essential features hereinbefore set forth, and as follows in the scope of the appended claims.

1. A process for preparing at least one neutral amino acid salt of polyunsaturated fatty acids (PUFAs):
mixing one or more PUFA in an acid form, an alkali base and a neutral amino acid in a mixture of a first organic solvent and water at a temperature of between about 0° C. to about the boiling point of said first organic solvent;
adding a second organic solvent to said mixture of said first organic solvent and water, in an amount effective for precipitating said salts of PUFAs; and
evaporating said first and second organic solvents and water to recover said neutral amino acid salts of PUFAs.

2. The process of claim 1, wherein said neutral amino acid salt of PUFAs is in a solid form.

3. The process of claim 1, wherein said PUFAs are comprising at least one of omega-3 and omega-6 PUFAs.

4. The process of claim 3, wherein said omega-3 PUFAs are comprising at least one of docosahexaenoic acid (C22:6 (n−3)) (DHA), eicosapentaenoic acid (20:5n−3) (EPA) and alpha-linolenic acid (C18:3 (n−3)) (ALA).

5. The process of claim 3, wherein said omega-3 PUFAs comprise at least one of eicosatrienoic acid (C20:3 (n−3)) (ETE), eicosatetraenoic acid (C20:4 (n−3)) (ETA), heneicosapentaenoic acid (C21:5 (n−3)) (HPA), docosapentaenoic acid (C22:5 (n−3)) (DPA), tetracosapentaenoic acid (C24:5 (n−3)), and tetracosahexaenoic acid (C24:6 (n−3)).

6. The process of claim 3, wherein said omega-6 PUFAs comprise at least one of linoleic acid (C18:2 (n−6)) and arachidonic acid (C20:4 (n−6)).

7. The process of claim 3, wherein said omega-6 PUFAs comprise at least one of eicosadienoic acid (C20:2 (n−6)), dihomo-gamma-linolenic acid (C20:3 (n−6)) (DGLA), docosadienoic acid (C22:2 (n−6)), adrenic acid (C22:4 (n−6)), docosapentaenoic acid (C22:5 (n−6)); tetracosatetraenoic acid (C24:4 (n−6)); and tetracosapentaenoic acid (C24:5 (n−6)).

8. The process of claim 1, wherein said PUFAs are comprised in a fat and/or oil.

9. The process of claim 1, wherein said PUFAs comprise EPA.

10. The process of claim 1, wherein said PUFAs comprise DHA.

11. The process of claim 1, wherein said PUFAs are comprised in a tuna oil.

12. The process of claim 11, wherein said PUFAs comprise 50-55% DHA and 20-25% of EPA.

13. The process of claim 11, wherein said PUFAs comprise 45-60% DHA and 18-27% of EPA.

14. The process of claim 1, wherein said PUFAs are comprised in seal oil.

15. The process of claim 14, wherein said PUFAs comprise 5-40% DHA, 5-45% of EPA and 3-10% DPA.

16. The process of claim 1, wherein said mixing step comprises providing an organic solution comprising said one or more PUFA in an acid form in said first organic solvent, providing an aqueous solution comprising said neutral amino acid and water, and mixing said organic solution and said aqueous solution.

17. The process of claim 1, wherein said neutral amino acids comprise glycine, α-alanine, β-alanine, taurine, leucine, isoleucine, methionine, serine, cysteine, threonine, tyrosine, proline, phenylalanine, homoserine, γ-aminobutyric acid (GABA), statine, or combinations thereof.

18. The process of claim 1, wherein the neutral amino acid is glycine, α-alanine, β-alanine, or taurine.

19-21. (canceled)

22. The process of claim 1, wherein said second organic solvent is ethanol or acetonitrile.

23. A neutral amino acid salt of polyunsaturated fatty acid (PUFAs) prepared by the process of claim 1.
